(19) United States
(12) Patent Application Publication
(10) Pub. No.: US 2009/0271318 A1
(43) Pub. Date: Oct. 29, 2009

(54) DIGITAL DATA LICENSING SYSTEM

(76) Inventor: Benjamin Filmalter Grobler, Pretoria (ZA)

Correspondence Address: Arthur M Reginelli, 4 th Floor, First National Tower, Akron, OH, 44308, US

(21) Appl. No.: 12/439,411

(22) PCT Filed: Aug. 28, 2007
(86) PCT No.: PCT/ZA07/00054

§ 371 Date: Feb. 27, 2009

(30) Foreign Application Priority Data
Aug. 29, 2006 (ZA) 2006/7188

(51) Int. Cl. H04H 60/23; H04H 20/71; H04H 60/21; G06Q 20/00; G06Q 30/00; G06Q 10/00

(52) U.S. Cl. 705/52; 705/59; 705/7; 455/3.01

(57) ABSTRACT

The invention provides a method for securing ownership of data and/or performances which are broadcast and/or performed in public, said method including an identifier in the broadcast and/or performed data, transmitting the identifier at a frequency and/or modulation which is neutral to the primary purpose of the data, receiving the broadcast and/or performance signal on a data carrier, and filtering the signal either at the time of reception thereof or at some point in time thereof to identify the identifier. The invention extends to a data carrier, a royalty management system, and a copyright management system using the above method.

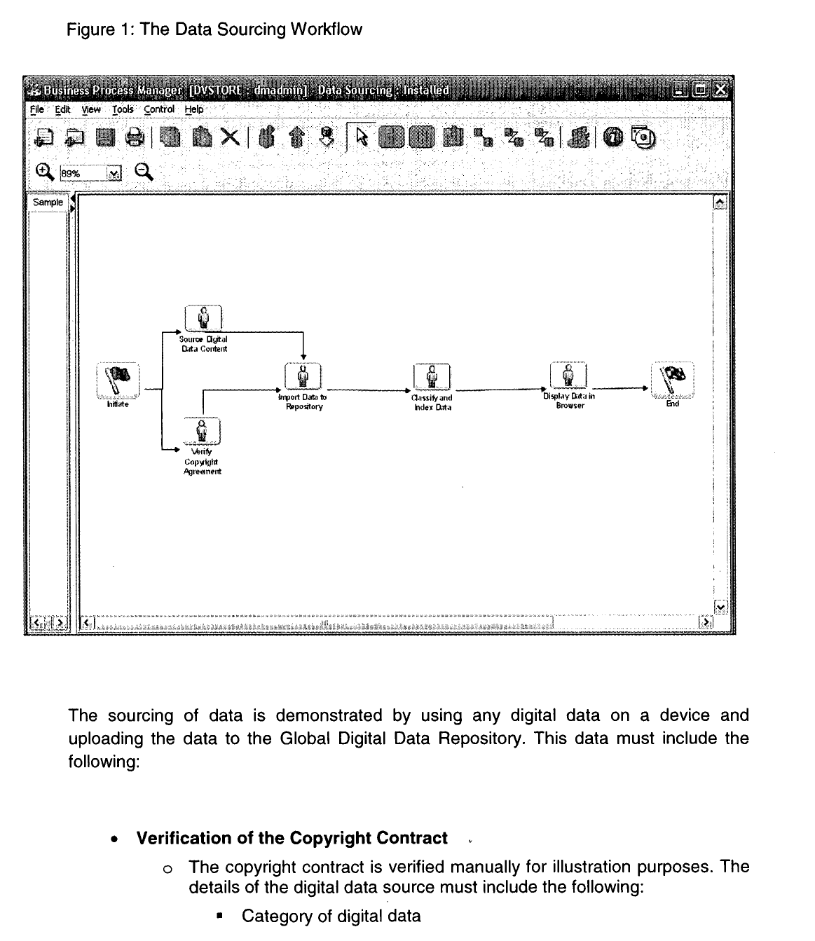

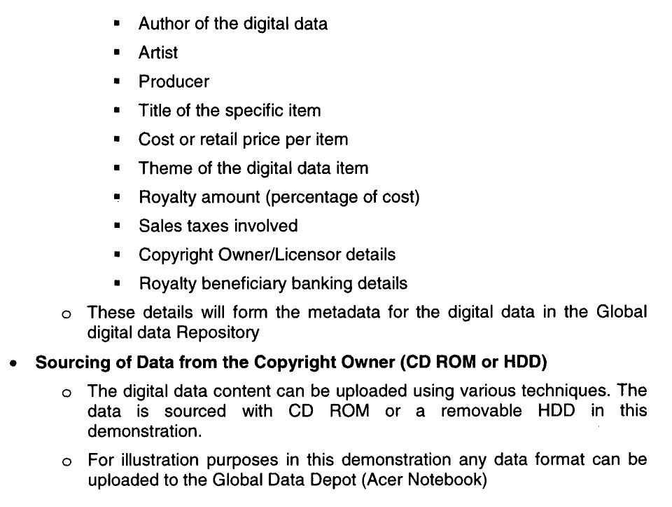

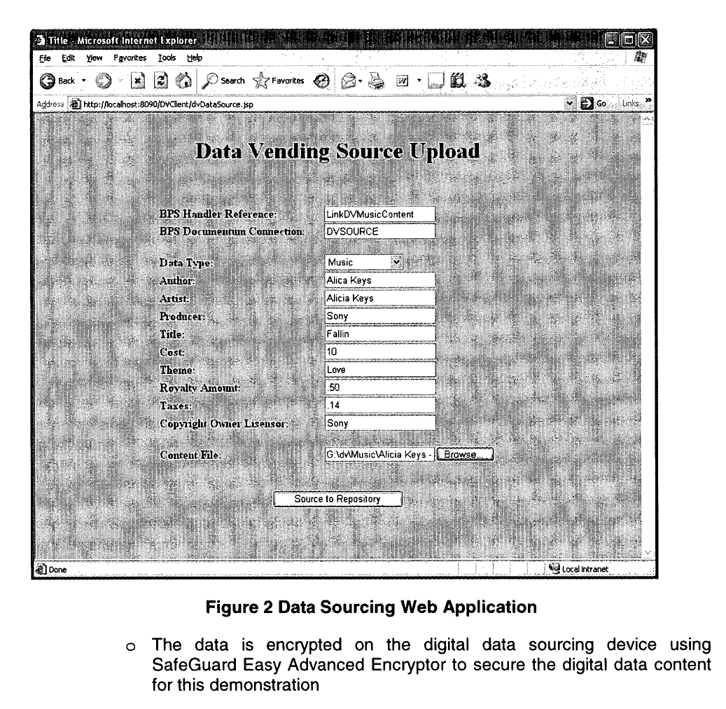

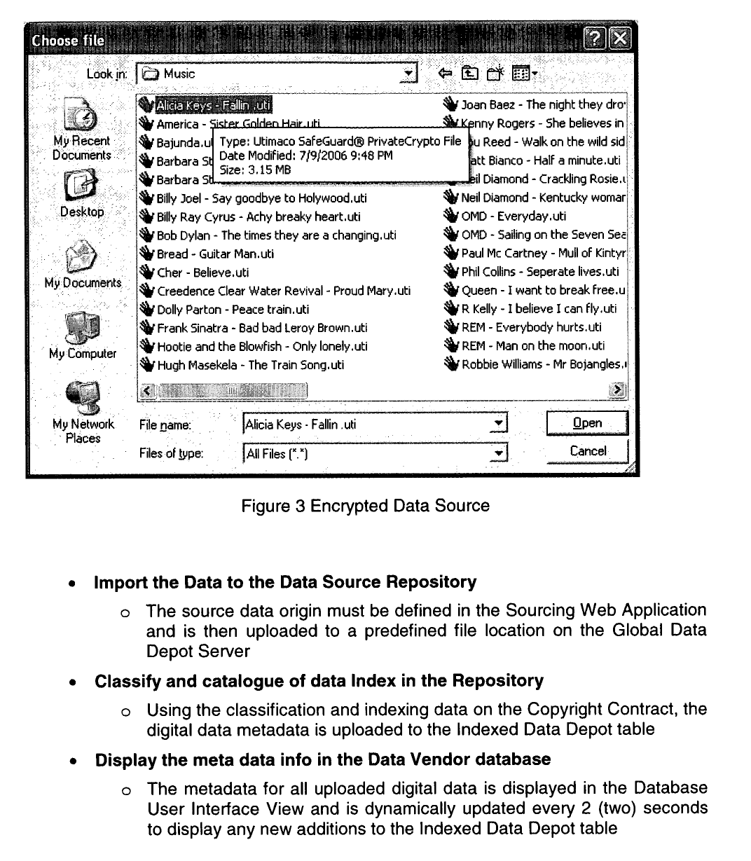

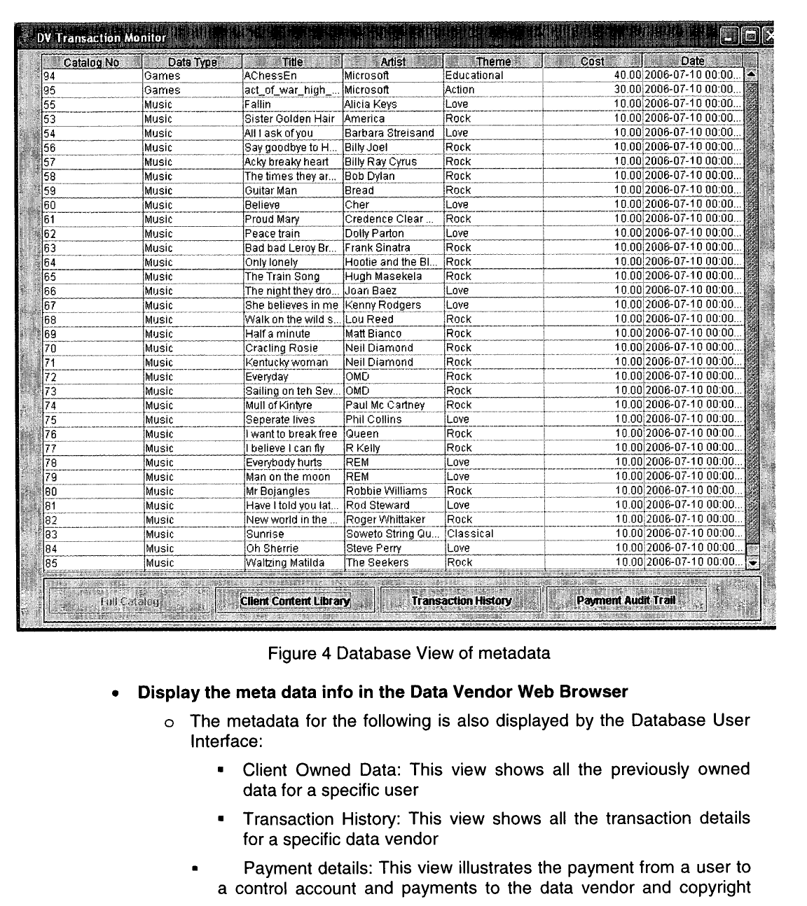

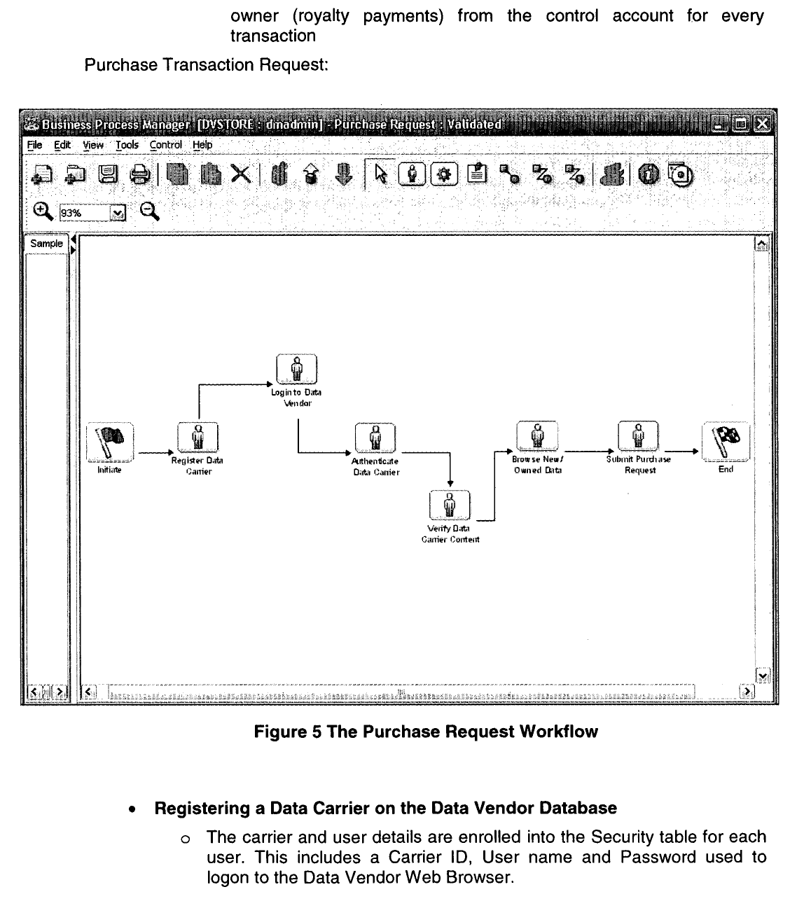

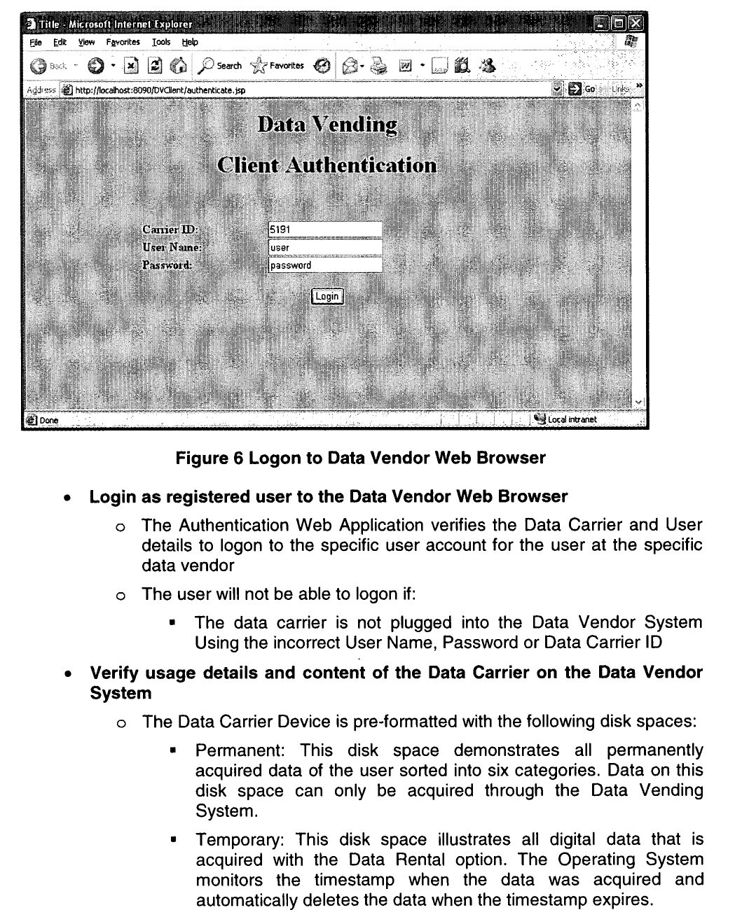

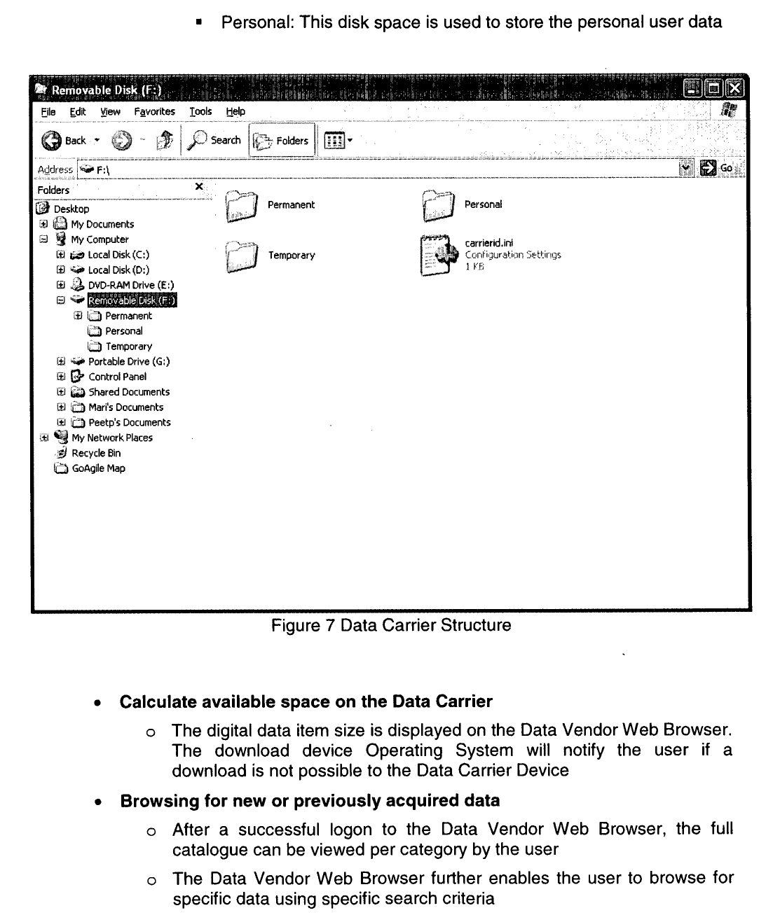

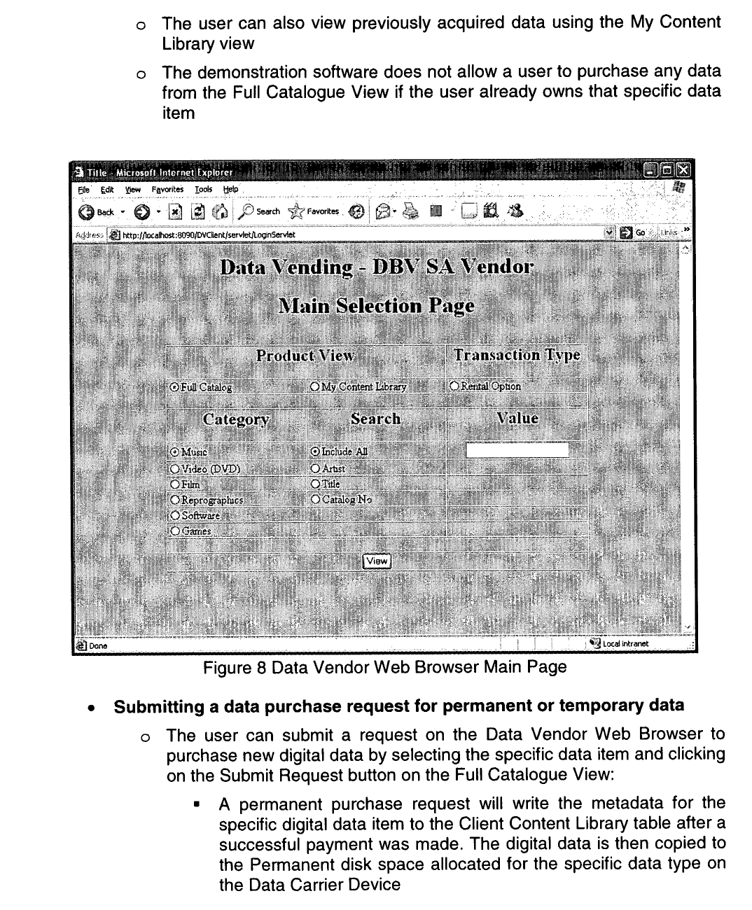

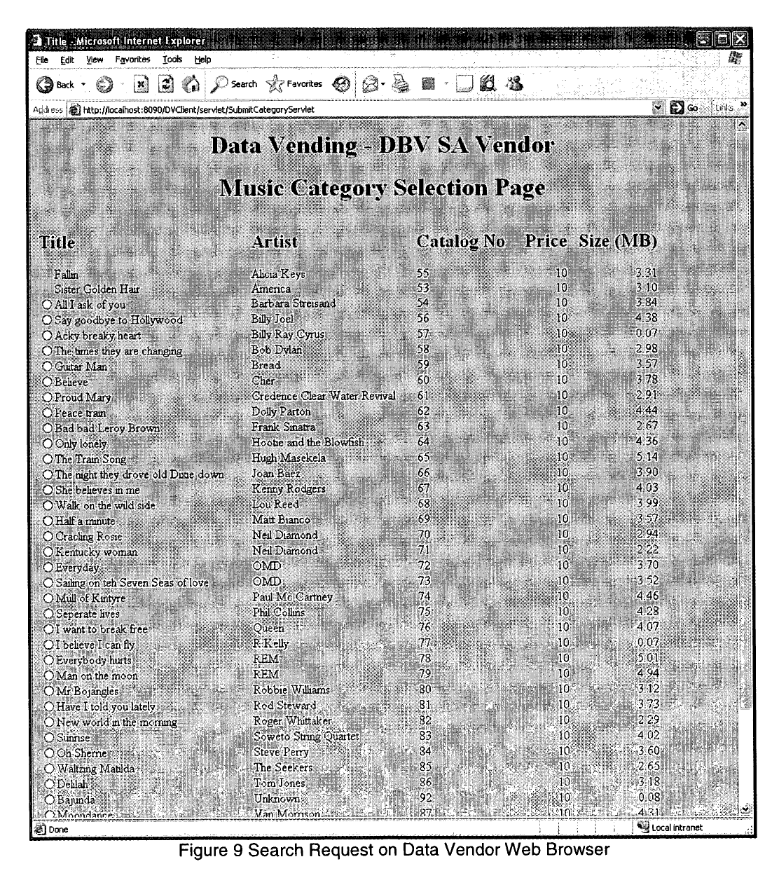

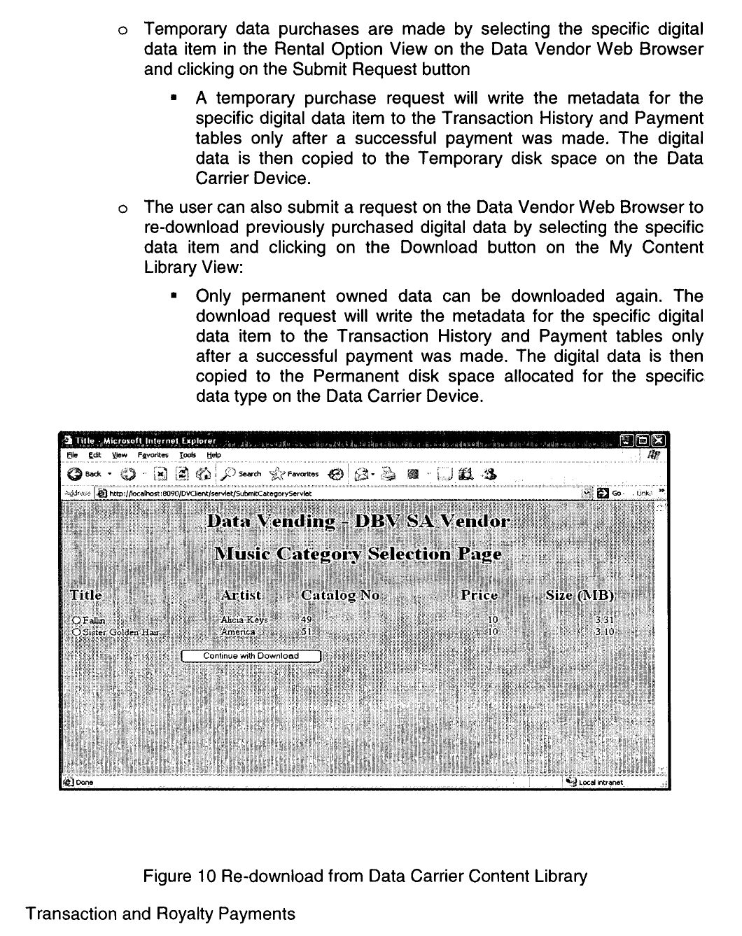

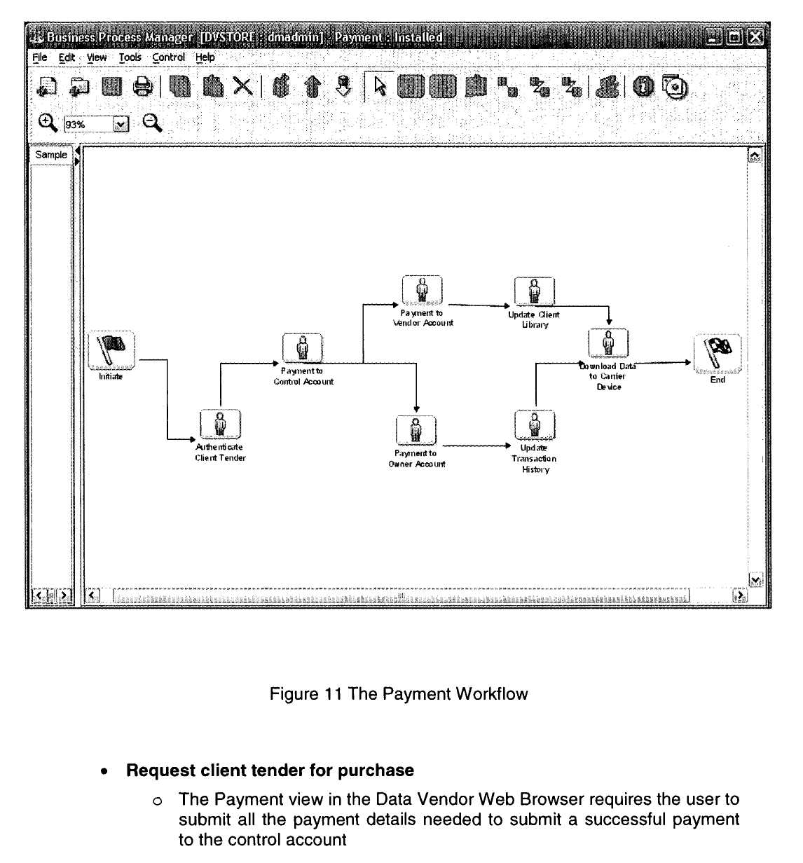

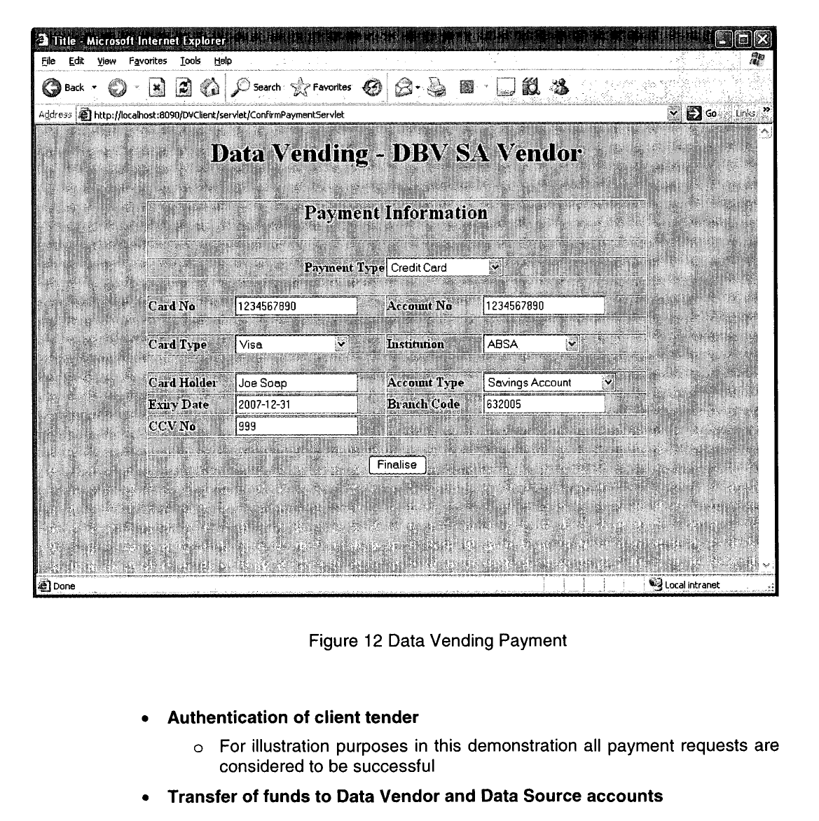

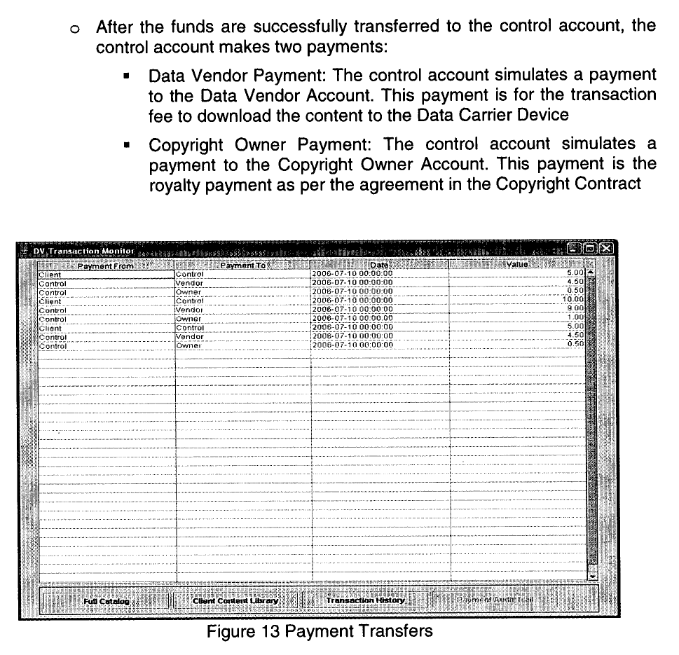

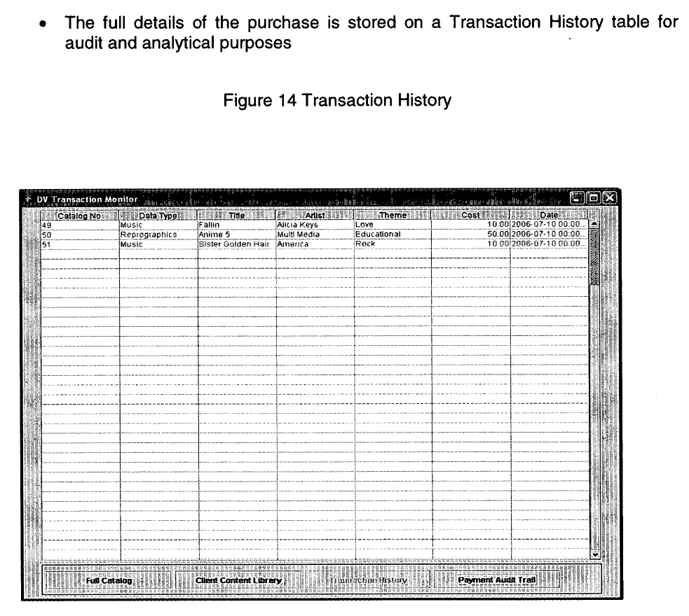

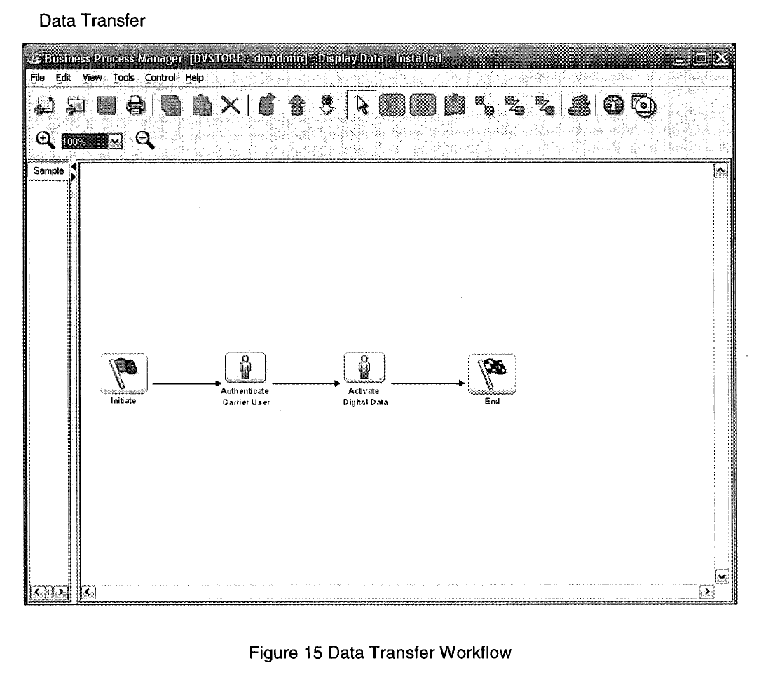

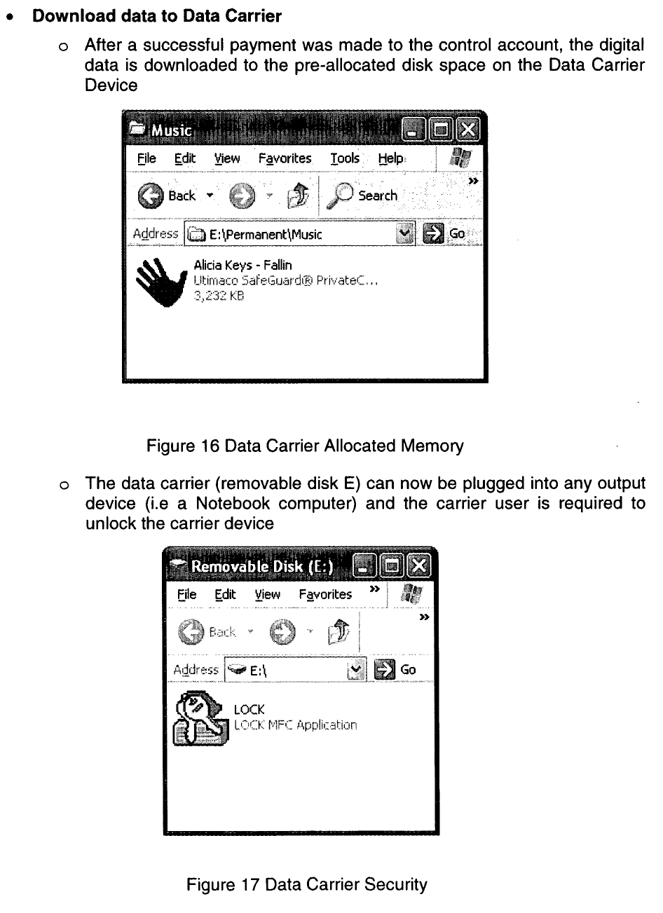

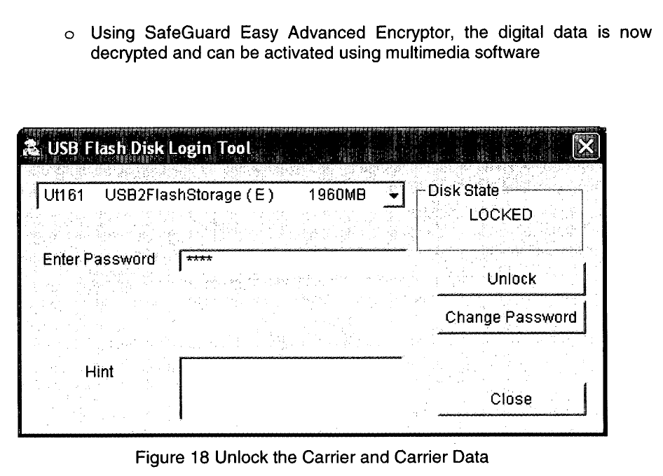

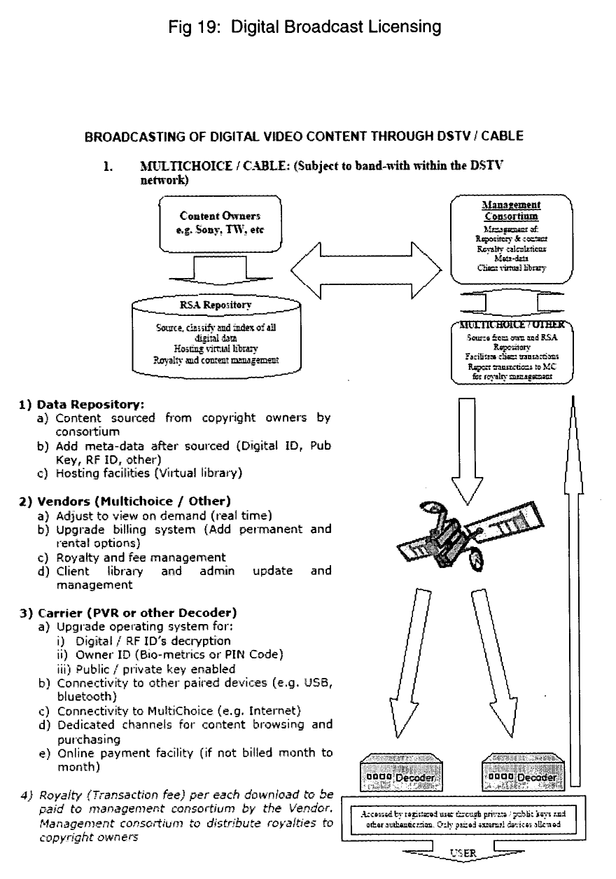

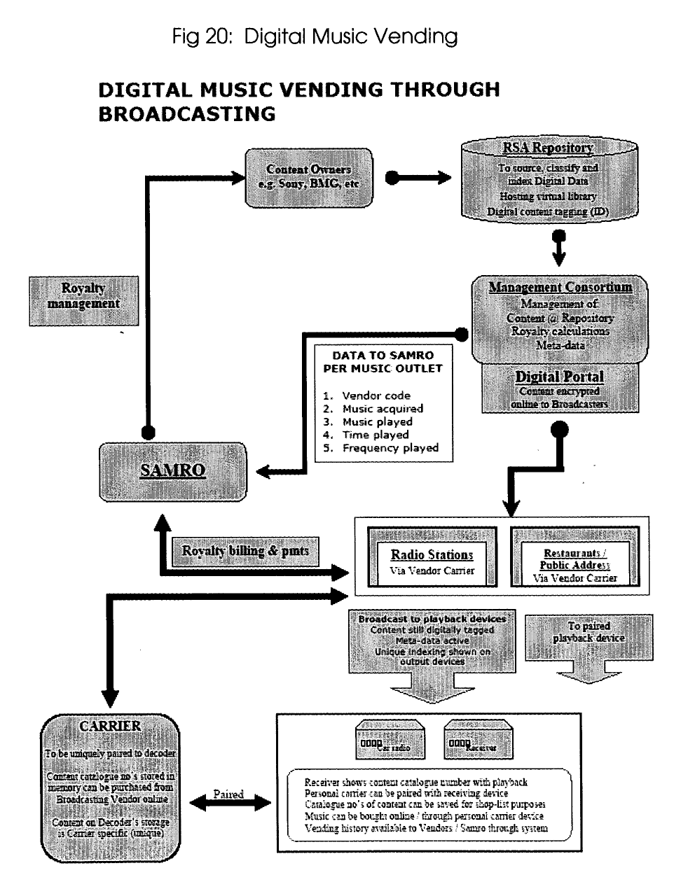

### FIELD OF THE INVENTION

The invention relates to licensing of digital data which is broadcast and/or performed in public.

### BACKGROUND TO THE INVENTION

The inventor is aware that presently copyright royalty losses are incurred due to unauthorised copying of data, such as music, videos, computer programs, and the like.

This copying usually takes the form of one or more unauthorised copies being made from an original or authorised copy.

The copying can also take the form of illicit recording of broadcasts and/or public performances.

The inventor is further aware that a need exists for a system which would simply allow a listener to a broadcast or public performance to legally obtain the data being broadcast and/or performed.

In U.S. Pat. No. 6,799,084 to Grobler, there is disclosed a data vending system including the storing of data such as digitised music and/or video and/or computer programs on one or more main computer i.e. the data depot and dispensing the data to a uniquely identifiable data carrier. The data on the data depot includes a database which maintains owner and/or possessor records for each said data carrier, the data being selected from the group including ownership or possession history of the data carrier, personal details of the past and present owner and/or possessor of the data carrier, demographic data about the user/owner of the data carrier, data recorded onto the data carrier at an authorised data dispensing device (either cumulatively or periodically, by title, by artist, etc), data rented and the rental period (either cumulatively or periodically, by title, by artist, etc), the user's normal requirements, the user's payment records, royalties paid to the copyright owner by the user, and favorite data of the user. This disclosure does not provide a solution to the above problems although it provides a convenient store for data once legally obtained.

### SUMMARY OF THE INVENTION

Thus, according to a first aspect of the invention, there is provided a method for securing ownership of data and/or performances which are broadcast and/or performed in public, said method including:
including an identifier in the broadcast and/or performed data;
transmitting the identifier at a frequency and/or modulation which is neutral to the primary purpose of the data;
receiving the broadcast and/or performance signal on a data carrier; and
filtering the signal either at the time of reception thereof or at some point in time thereof to identify the identifier.

The identified identifier may be catalogued in relation to the data carrier.

The identifier may be used to select specific portions of the broadcast and/or performance which a user of the data carrier desires to legitimately obtain.

The user may either immediately download the selected portions or queue these portions for later download.

The system may include:
recording an inventory of legally obtained data which may be present on a specific data carrier;
interrogating an incoming signal or the data carrier on which said data and/or performance in the form of data has been saved for the identifier; and
reacting to the presence of the identifier or unrecognized data on the data carrier with one of a number of predetermined actions in response to whether unrecognized data is present or whether the identifier is recognized as being illicitly present on the data carrier or not when compared to the inventory.

The identifier may be an encrypted key.

The identifier may include a catalogue number, a source identifier, a cost label, and/or information usually associated with barcoding of tangible goods.

The interrogation may include attempting to decrypt any unrecognized data.

Where decryption fails, data format cannot be recognized, or there is restriction of access to the data on the carrier device, responding with one of the predetermined actions as if an illicit identifier had been recognized or any other predetermined action.

Where the identifier is read and decrypted and the data or performance is found to be authorized the data may be used normally.

Where the identifier is either not recognized or recognized to be illicit then the data carrier may be locked and require a corrective action to be taken selected from the group including, but not limited to, legalizing the data by paying for it, paying a fine, deleting the unauthorized data, deleting the entire content of the data carrier, deactivating the data carrier, and the like.

The method may include receiving the digital content carrying signal.

The method may include identifying the location at which the signal is received before permitting the data to be saved to the data carrier.

Thus, only a data carrier and/or a receiver at an authorized location may be authorized to access content.

According to a further aspect of the invention, there is provided a method for obtaining content from a broadcast or a performance, said method including:
including an identifier in the data and/or performance;
transmitting the identifier at a frequency and/or modulation which is neutral to the primary purpose of the data and/or performance;
interrogating the performance and/or broadcast for the identifier; and
at the option of a user, marking for future download or real time capturing onto the data carrier a data set or a performance associated with the identifier.

The method may include processing payment for the marked and/or downloaded data.

The payment may be in more than one stage, the first stage for marking and recording the selection to an inventory associated with a particular data carrier, and one or more further stages associated with the downloading and/or use of the data.

The invention extends to a data carrier of the type described in U.S. Pat. No. 6,799,084, said data carrier further including:
means for receiving an incoming signal and locating the identifier described above in an incoming signal or in data saved on the data carrier; and
a CPU readable instruction set provided on the data carrier for carrying out one or more of a set of predetermined actions in response to the identifier.

The data carrier may include decryption means for decrypting an encrypted identifier.

The data carrier may include actuation means for permitting a user to mark a particular data set or performance having a recognized identifier for immediate or future download. The actuation means may be a soft key associated with a display.

The data carrier may include payment means to enable payment for marked or downloaded data to be made.

The invention extends further to a broadcaster royalty control system, said system including:
uniquely allocating data carriers to a broadcaster;
indexing authorised and catalogued digital content which is installed on the carriers for a particular broadcaster;
uniquely tagging each item of digital content, such as a song, advertisement or other audio items with a unique catalogue number and/or other information in a transmittable format which is neutral to the purpose of the digital content; and
downloading or streaming digital content the broadcasting carrier(s) from a controlling depository, which downloading or streaming may be as updates or new data content.

The system also provides for a radio station choosing the song (item) to be played i.e. broadcast from the menu on its broadcasting carrier. As such item (being it a song, advertisement or other catalogued and identifiable content) is broadcast, the broadcasting carrier will log such item as having been broadcast with relevant supporting detail (such as date and time references) for the purpose of tallying and control.

An item may be tallied (counted) upon either partial or complete broadcast thereof.

In the case of advertisements, the advertiser wants to pay for the broadcasting of the complete item, but with music even a part of it warrants payment. This may be managed by a digital start-, intermediate- and end-signal value which can be triggered/chosen through pre-settings as needed.

Royalties for the music played by the radio station, in relation to the radio station's license fee, may thus be allocated and distributed accurately in real time, based on the monthly or other periodic reports which is supplied to a licensing body.

Advertising may be managed and controlled in terms of time or incidences over the air.

Each advertisement may thus also be uniquely catalogued and identified by a unique identifier.

As music or other protected content (under copyright) is broadcast, the item's unique catalogue number and RF-identification may be broadcast as well, but at a frequency which is inaudible to the human ear.

The listener may access the catalogue reference of this item through an adapted receiver, such as a car radio or tuner, and can store this item on a unique user data carrier as a potential purchase on a storable shopping list.

Alternatively the user may order the purchase of this item from the vendor, which may be a radio station in this case.

The data repository may receive the user's order via the radio station (vendor), which receives a potential commission on the sale.

After the transaction has been verified as being in line with the controls of the process, as envisaged in U.S. Pat. No. 6,799,084, and payment for this item has been effected, the repository will allow the specific user data carrier to download or stream the permanently or temporarily purchased digital content to that specific user data carrier in a uniquely encrypted format.

As a consequence of the above system, the repository may warn the user data carrier of illegal content i.e. unauthorized content stored thereon or that a specific item has already been purchased previously, to name but two issues.

The method may include receiving the digital content carrying signal.

The method may include identifying the location at which the signal is received before permitting the data to be saved to the data carrier.

The method may include identifying the location of the data carrier on which the digital content is to be stored. This may form part of the authorization process.

The digital content may include meta-data.

The meta-data may be embedded in the digital content.

Identifying the location at which the signal is received may include GPS methods, internet address methods, mobile telephony methods, or any other suitable method.

The invention extends to a broadcast system for a hot-spot, being a special zone within which a broadcast signal is receivable, which hot-spot system includes:
allocating a unique hot-spot data carrier, similar to that described above as a data carrier for a broadcaster, to a specific hot-spot and geographically locking it to that location, for example, by GPS co-ordinates;
authenticating a user data carrier and permitting it to log into the hot-spot data carrier, also termed as pairing the user and hot-spot data carriers;
broadcasting digital content to paired user data carriers; and
vending digital content selected by a user of a user data carrier to that user's data carrier.

The user may select digital content for immediate purchase and/or download, or capture the unique identifier of desired digital content for later purchase and/or download.

The hot-spots may be located in restaurants, shopping malls, airplanes, ships, busses, trains, airports, bus stations, and any other such place.

Wherein the geographical locking includes pre-determining boundaries of an authorized geographical location within which the hot-spot data carrier operates using GPS co-ordinates, IP address, or triangulation position and preventing the hot-spot data carrier from fully functioning outside these boundaries.

The invention extends further to a management system of copyright of performed content which is performed live, said system including:
providing a source of a unique identifier to be associated with a live performance, such as a catalogue number and a digital signature;
transmitting the unique identifier contemporaneously with the live performance; and
depositing with a data repository the unique identifier so that, if a data carrier user connects to the data repository to download data and the unique identifier associated with the live performance is found but is not authorised, then appropriate corrective measures may be instituted.

The invention is relevant to all forms of digital content including music, video, software for gaming computers and consoles, computer software, reprography, and the like.

### DESCRIPTION OF EMBODIMENTS OF THE INVENTION

Although the invention is not limited to any specific embodiments, the inventor presently foresees at least the following uses for the invention which are also shown graphically in the attached schematic representations. These embodiments form an integral part of the disclosure of the invention in this specification and are intended to convey general concepts rather than specific details.

### 1. Digital Broadcasting Data Carrier (Audio)

1.1 All radio stations (audio broadcasting units) are supplied with uniquely allocated data carriers which has authorised indexed and catalogued digital content which is installed on the unit.
1.2 Each song, advertisement or other audio items (such as interviews or talk shows) carries a unique catalogue number and a unique RF-identification (“signature”). This signature entails a sporadic or continuous sound combination which is inaudible to the human ear, due to its hertz frequency (thus not in any way polluting the quality of the audio item). This unique “signature” can be traced/identified for control and management purposes.
1.3 New authorised releases, (in respect of additional digital content) are sent (downloaded/streamed) to the broadcasting carrier(s) from a controlling depository (global or centrally managed “virtual digital library depot”) as “updates” to the specific carrier(s)' memory and are as such indexed and catalogued for control and management reference purposes. The broadcasting carrier may also download additional content from the depository if authorised to do so by linked access e.g. coding/keys which are managed by the repository.
1.4 Operationally, the radio station will typically choose the song (item) to be played (broadcasted) from the menu on its broadcasting carrier. As such item (being it a song, advertisement or other catalogued and identifiable content) is broadcasted, the broadcasting carrier will log such item as broadcasted with relevant supporting detail (such as date and time references) for the purpose of tallying and control.
   An item can be tallied (counted) upon either partial or complete broadcasting, whatever the choice. In the case of advertisements, the advertiser wants to pay for the broadcasting of the complete item, but with music even a part of it warrants payment. This is managed by a digital start-, intermediate- and end-signal value which can be triggered/chosen through pre-settings as needed.
   Royalties for the music played by the radio station, in relation to the radio station's license fee, can thus be allocated and distributed accurately in real time, based on the monthly or other periodic reports which is supplied to the licensing body (such as SAMRO which acts on behalf of its composing members in South Africa) and advertising can be managed and controlled in terms of time or incidences over the air. Each advertisement is thus also uniquely catalogued and identified by a unique RF-identification.
1.5 As music or other protected content (under copyright) is broadcasted, the item's unique catalogue number and RF-identification is broadcasted as well, but at a hertz level which is inaudible to the human ear.
1.6 The listener can now access the catalogue reference of this item through an “adapted” receiver (e.g. car radio or tuner) and can store this item on his unique “user data carrier” as a potential purchase on a storable “shopping list” or can alternatively order the purchase of this item from the vendor, which may be a radio station in this case.
1.7 The data repository will receive the user's order via the radio station (vendor), which receives a potential commission on the sale. After the transaction has been verified as being in line with the controls of the process (as envisaged in U.S. Pat. No. 6,799,084) and payment for this item has been effected, the repository will allow the specific “user data carrier” to download or stream the (permanently or temporary) purchased digital content to that specific “user data carrier” in a uniquely encrypted format.
1.8 One obvious control is that the repository will warn the user data carrier of illegal content on its memory and that this specific item has already been purchased previously, to name but two issues.

It follows then that:
A radio listener can now identify broadcasted content, store its unique reference on a “shopping list” and potentially buy it (either temporarily or permanently) through utilising any “adapted receiver” which is “linked” or “paired” with his unique “user data carrier”.
(It is a frustrating to listeners when they hear a song which they would like to buy, but they do not know the name or artist in order to buy it, since some radio stations do not mention this detail anymore.)
Radio stations now have the ability to become “vendors” of digital audio content (which is protected by copyright) and can also receive income from it. Currently they are deriving income from airing advertisements only. They are the ideal vendors since they advertise the music all the time.
The “representative” of copyright holders (such as SAMRO—the South African licensing body for composing members) can now obtain accurate reports of specific content that was broadcasted, enabling them to allocate and distribute the net collected license fees as “royalties” to the composers on exact information which is obtained from reports obtainable from the respective unique “broadcasting data carriers”.
A lot of value can also be derived from statistics which are accumulated through this process.
In the foreseeable future, record companies can also derive income (on behalf of their member “performing artists”) on a similar basis, based on the same source of information. Legislation towards this is in place in many countries now and the regulations are expected to be coming any day now.
The “digital content” (e.g. song) to be broadcasted, now carries a permanent and unique “signature” over the air and if copied illegally, that specific content could later be traced as to where it had originated from and to whom the initial authority (ownership or broadcasting rights) was given to. If it is ever stored on a “unique user data carrier”—(as envisaged in U.S. Pat. No. 6,799,084), without being duly acknowledged as authorised protected content; the culprit can be traced and dealt with accordingly. If for example it is stored illegally on a “user data carrier”, the item will be traced through its signature as an item which has not been authorised for that specific user data carrier. The owner/user will then have the potential result of that carrier being locked/blocked/blacklisted. The illegal item can potentially be removed or a fine may be payable before that carrier is be made operative again.
   2. Public Performance (Speaker/Screen-Integrated Unit with Limited Hot Spot Area)

This refers to the operational application of the envisaged process at establishments such as discotheques, shopping malls, clubs, restaurants, sport stadiums and other places frequented by patrons.
2.1 In most developed countries it is required by law that such establishments pay a license fee to a licensing body acting for member composers and in the near future potentially also to record companies (representing the performing artists) or even royalty agents (in respect of “mechanical recording of a phonographic performance). The respective license fees are normally calculated on the average number of “seats” or patrons/listeners that are expected to frequent the establishment (where “copyright protected content” will be aired). Again it is difficult to distribute these collected license fees fairly between the numerous composers/artists. Many of these establishments are illegally using copyright protected content for the pleasure of their patrons (normally a computer with illegal songs in MP3 format or an “i-Pod”). A unique carrier, similar to the broadcasting unit mentioned in (1.1) above, is allocated to the specific establishment and is geographically locked per GPS location.
2.2 The establishment can now “air” any available content legally and its audience can even purchase the broadcasted content by pairing their personal unique “user data carrier(s)” with the establishment's carrier through Bluetooth or other connectivity. Many such places are “wi-fi enabled” (hot-spots) already. The optional download of purchased items will thus be easy. It follows that such establishments can also become vendors of audio content if other “user data carriers” are paired to it. The potential of audio-visual content formats such as music-video, -DVD, -Blue Ray, -iVDR, etc. are similarly functional and obvious through the same process.
2.3 It follows then also that airplanes, trains, hotels, guest houses, etc. may have similar applications, although it may be restricted as bouquets with smaller limited content.

### 3. Live Performances (Recording Rights)

This refers to live music shows, comical shows, cinema etc where the possibility exists that someone in the audience can copy the content which is supposed to be copyright protected. (bootlegging)
3.1 The performing artist(s) utilises a unique “performance data carrier”, which is integrated in the transmission equipment, thus airing a uniquely allocated “signature” (RF-identification) which will enable later detection if it is ever copied to a unique “user data carrier” without proper authorization.
3.2 This will discourage the illegal copying of live performances and the distribution of such illegal content to a unique “user data carrier” (as envisaged in U.S. Pat. No. 6,799,084). When illegal content is stored on a “unique data carrier”, such content can be detected through the allocated signature embedded in the content (RF-Identification) and appropriate action can then be taken.

### 4. Digital Broadcasting Data Carrier (Multimedia)

It is expected that users will soon utilise different models of universal portable “user carriers” as envisaged in U.S. Pat. No. 6,799,084. This will typically be a unique unit which is a combination of a cellular phone, camera, GPS, radio (RF-receiver), music player, video player, TV-receiver, game station and computer. It follows logically that user would want to carry only one device through which they can access all digital content to which they have legal access. The access will probably be managed by various processes and controls applied by a federal repository (virtual digital library).

It follows that the user would have the need to link or “pair” the above mentioned device (user data carrier”) to various linked systems in various environments. The process thus relates to a potentially shared environment where more than one “user carrier” can access various broadcasted digital items by pairing to an “adapted receiver”. The typical environments include:

### 1. Home Entertainment

### 2. Office Applications

### 3. Public Entertainment

In addition it is also envisaged that all broadcasted multi-media content also be tallied as is discussed earlier.

4.1. Home Entertainment

In the home environment, the “general receiver” will be able to access a range of broadcasted, downloaded or streamed items (digital content). In simplicity, the existing “DVR” decoder unit utilised by Multichoice's DSTV in South Africa or the “Cable-TV” decoder units utilised in other countries are adapted to receive encoded and encrypted digital content.

Currently encoded content is received by such units and such content can be recorded and copied, which poses open risk to piracy of intellectual property. The idea is that the certain protected digital content should be decoded or decrypted only when the specific “user data carrier” which has legal access to such content, is “paired” to it. Such pairing can be managed by GPS application on both units. In addition the receiving unit should be equipped with coded access (PIN) in order to limit pairing with “user data carriers” to authorised users only.

The GPS application and coded access (PIN) of the receiver prevents it from being utilised when stolen (it is operative to a specific geographic address and authorised user only) and the GPS application of the “user data carrier” limits illegal distribution of content authorised to that specific “user data carrier”.

It is envisaged that the receiver will form part of an integrated system, potentially including various linked or paired TV's (or screens), amplifiers, graphic equalizers, speakers, PC's, laptops, play-stations or any similar equipment. Depending on the specific system's available peripherals, any paired “user data carrier” can therefore access any authorised content from a broadcaster or the repository (envisaged in U.S. Pat. No. 6,799,084). The potential memory capacity of the system can therefore be utilised by a number of “user data carriers”, although the content can only be decrypted by the specific “user data carrier” which has authority to do so. The adapted receiver (decoder) of digital content (being broadcasted, cabled, downloaded or streamed) thus acts as a receiver and potentially an auxiliary (extended) memory for user data carrier(s) paired to it. It follows then that various users can link or pair their “user data carriers” to such decoding receiver which provides potential connectivity to the whole system at that address.

4.2. Broadcasting

A broadcaster (by cable, satellite transmission or other means) can broadcast protected content” in a coded and/or encrypted format with a “signature” as mentioned earlier. The protected data broadcasted can therefore be a “package” with a specific content which is accompanied by “*meta-data” (see at bottom) which may include various fields of information, similar to the “digital package” which is disbursed by the repository envisaged in U.S. Pat. No. 6,799,084.

If certain content is “open” the user can record or even copy it and can potentially commit piracy on it. If on the other hand, limited use is permitted, a date and time stamp can allow decoding/decrypting for a specific period only. Or, as envisaged earlier, such content can be purchased by the user, by procuring the digital item for a specific “user data carrier”.

Typically then, a broadcaster can broadcast movies, news, music, etc. to a decoder for “real-time” or temporary use (limited time). If the user should record such content, the access to it is potentially restricted to a specified time period.

The broadcaster can now offer a menu of additional digital items (such newly released movies, games, etc) which can be procured for a specific “user data carrier”. It follows then that if a user wants to see a movie which is not on the normal menu/bouquet of the broadcaster, he can rent/buy it, for the exclusive use of his specific “user data carrier”.

It follows thus, that the request for the specific digital item chosen by a user or “owner” of a “user data carrier” is then procured from the “digital repository” as envisaged in U.S. Pat. No. 6,799,084 and that the multimedia broadcaster can then potentially receive a commission on it. It is obvious then that the multimedia broadcaster will become a vendor of movies (replacing video/DVD/Blue Ray/iVDR or similar outlets), video-games and even certain software.

Although the “user data carrier” may have been able to accommodate all the above directly, the “home receiver” is a useful piece of equipment, since it is already connected with TV's, screens, PC's laptops, speakers, etc in the home environment and provides entertainment for the whole family. The “home receiver” can also provide additional memory capacity for all the linked or paired “user data carriers”.

The “home receiver” is envisaged to become the central receiver, distributor and memory/storage device in the residential environment. It will only decrypt protected content which is authorised for “user data carriers” which are linked or paired to it.

It follows that it is envisaged that existing decoders for Cable-TV, Satellite-TV etc. will evolve to become universal “Receiving devices”.

Such a “home receiving device” can therefore also be utilised in guest houses, hotels, etc.

If the user of a “user data carrier” is then able to link or pair to a “receiver” in a car or a home, he can access digital content which is authorised for that specific “user data carrier”. This will enable a user to listen to his music collection in a rented car, or a car of a friend and will give him access to his movie collection, games or even software when linked to an “adapted decoding/decrypting receiver” when his “user data carrier” is paired to such device. Although the “user data carrier” provides access in itself, it thus also becomes the “key” through which access can be accomplished through installed systems with bigger screens, keyboards, speakers, etc.

4.3. Office Environment

Most offices have computer servers, connected to various “work-stations” and in many cases the boardroom has a decoder connected to a TV or screen. It is envisaged that similar to the home environment, the office environment will also provide a central “decoding/decrypting receiver” which device can receive and store digital content which can be accessed only by those “user data carriers” which are authorised to do so.

Since it is expected that digital content will be categorized by the “repository” as envisaged in U.S. Pat. No. 6,799,084 the office will be able to allow only certain categories, if it so wishes. In this way it can prevent employees from access to games, pornography, etc.

It will be ideal to carry all software utilised within that closed environment on such a device, since the number of users, the geographic location, etc can be managed and controlled in this manner. Again access (also to the software) is limited to “user data carriers” with due authority, which are paired to the system.

It follows then that the envisaged “decoding/decrypting receiver” can harbour digital content which is inaccessible or unreadable unless linked or paired with a “user data carrier” with authority to do so!

The mentioned receiver will obviously have the means to erase all data on memory which was dedicated to a specific “user data carrier”. If a user leaves the employ of an employer, they can merely erase his authority to link or pair with the device and erase any data he had in memory.

Software houses can now very easily police the number of users of their software at any point in time by on-line access to the user-records of the system.
Meta-data will be incorporated as part off the digital package and will typically include the following:
   date stamp
   time stamp
   valid period
   vendor reference
   title
   artist/author
   indexed code
   unique catalogue number
   begin, intermediate and end signal
   price
   length or size
   genre or class
   keys
   encryption trigger
   encoding trigger
   signature

### EXAMPLE OF AN EMBODIMENT OF THE INVENTION

### Data Vending System Specifications

### Data Depot & Data Vendor:

Introduction:

The data depot i.e. a global content digital library that is interlinked from country to country that will ultimately represent one large federated repository. This repository will be used to source digital data from all relevant data owners and suppliers, index, catalogue and store the digital data content.

The data vendor content digital library is a subset of the federated repository that will be located at local data vending outlets. These outlets will serve as physical data outlets or as online data vending service providers, distributing digital data to registered carrier devices.

Management data containing history of carrier transactional data, royalty payments, and commissions to vendors will be captured and stored at the federated data repositories. These data will be available to all accredited data vending service providers and relevant data owners and suppliers.

Current proven best practices e.g. ITIL for hosting, maintaining, safeguarding and managing (housekeeping) data will be used for these data stores.

International standards for disaster recovery and business continuity will be designed, tested, implemented and regularly audited against quality assurance standards like O.S.K.

The envisaged data libraries will consist of the following as a basis to source, index, catalogue, store, and distribute digital data content namely:
1. Data Sourcing
   a. Open standards to input digital data from current multi media formats.
2. Data Indexing
   a. International accepted standards will be utilised
   b. Unlimited metadata that describes the digital data can be added for identification and indexing purposes of the digital content
3. Catalogue Data
   a. International accepted standards will be utilised
   b. Unique characteristics will be used to authenticate digital data. These characteristics will be the unique catalogue identifier.
4. Data Storage
   a. Once sourced, the data must be kept secure and only available for authorised access.
   b. Data on the data repositories must not be recognisable or usable unless unlocked.
   c. Data integrity and confidentiality will always be the highest priority
5. Data Access
   a. Data will be accessible and available over secure and private networks with minimum time lag.
6. Data Outlets
   a. Must provide secure, standard ways of communication between data carriers and the data vending system.
   b. Must provide for standard mechanisms to accommodate client tenders.
7. User and Carrier Registration
   a. Authentication of carrier devices and users must be accommodated via current identity management systems.

### The Data:

The data in the data vending concept can be provided in any digital format. For indexing and cataloguing of the data any number of metadata attributes can be added to describe the specific data item.

Embedded in the data a digital signature must be added to uniquely identify the specific data item together with the data carrier that purchased the digital data content and the purchase details of the digital data.

For example:

Embedded data signature=Carrier ID+Digital Data Code+Transaction Code

This unique signature will be stored on the Global Repository for each transaction to allow the data vending system to monitor if any foreign data was allowed on the data carrier and to take the necessary steps in such case.

The specifications for the use of public and private keys are well known and together with a number of available technologies the embedded signature can be achieved with minimal effort.

### Data Carrier:

Introduction:

The typical carrier will be close to what is already available on the market today in the form of new generation cellular phones. Already embedded features include data input lay-out keyboards, SVGA Screens, Large Memory Capacity, USB Connectivity, Multi-media features, GPS, and other.

Typically a Data Carrier should have the following as a basis to operate on the Data Vending System, namely:
1. Connectivity to Networks
Connectivity to the networks is essential to do transactions to the data carrier.
The digital data content should only be accessible in two ways:
   a. Physical Data Vendor Transactions:
   The client takes the data carrier to a registered data vendor and physically connects the data carrier device to the data vending system with one of the following:
      i. USB Connection
      ii. Wireless LAN Connection
      iii. Bluetooth Connection
      iv. Any other relevant connectivity technology
   The client can then do any new data purchase, download previously owned data or only browse for digital data available on the Global Data Repository (Data Depot)
   The payment for any data purchase can now be facilitated by the Data Vendor and data download can be done from the local repository at the high speed this type of local network allows.
      b. Remote Data Vendor Transactions:
   The client connects the data carrier to any device with the ability to connect to the internet and logs on to a Data Vending System Web Browser
   Connectivity to the Data Vending System Web Service can be done via:
   i. WAN Networks
   ii. Telecoms Networks
   iii. Radio wave technology
   iv. 3G/GPRS/HSDPA (Mobile networks)
   v. Satellite technology
2. Display (SVGA)—Internal/External
   The display capability of the data carrier allows the user to view the digital data on the data carrier in high resolution using current technology. With the necessary connectivity the client can do data purchase requests on the Data Vending System.
3. I/O Device—Keyboards, mouse, etc (Internal/External)
   The data carrier needs the capability to receive input from the user to access the data on the carrier and to do data vending requests on the data carrier. The data carrier should have a keypad embedded on the device or be able to connect to external keyboard/mouse or any other input device.
4. Identity Manager (Biometric/Code driven)
   The user needs to authenticate the ownership of the data carrier device to access the digital data on the data carrier and to authenticate purchases on the data vending system. This can be achieved with an embedded private key on the data carrier and using a pin code or fingerprint using biometric technology.
   The private key on the data carrier is a unique code given to every data carrier and is linked on the data vending system to a specific user.
5. Power Supply (Rechargeable and AC)
   The data carrier will need a rechargeable battery to power the components it embeds.
6. SIM/Smart Card Enabled (Embedded Carrier ID)
   The data carrier can make use of a SIM or Smart Card to achieve connectivity to networks and to do data vending purchases on the data vending system
7. Output Connectivity
   The data carrier must be able to connect to any output device like monitors, TV, Home entertainment systems etc. This connectivity can be achieved by using number of current technologies
8. Operating System
   The data carrier operating system allows the data carrier to monitor the content on the device and allows the user to manage the device using the current standards of operating systems
9. Web Application Enabled (JAVA/Dot.Net)
   Due to the nature of the data vending system the data carrier has to be able to handle Web applications
10. Security Applications
   The security applications allow encrypting and decrypting of the digital data for distribution. The security can be handled by a number of existing applications.
11. Ad Hoc—E.g. Camera, GPS, Recorders, etc.
Storage Allocation: (Typically 3 types of Storage)
1. Permanent Storage: (Read-only for Data Carrier User)
   For use with Permanently Acquired Data receivable only through Data Vending Solution, e.g. music files, images and other bought Data.
2. Temporary Storage: (Read-only for Data Carrier User)
   For use only through Data Vending Solution when temporary access to specific data is required for a pre-defined period, e.g. movie rentals, demo software, etc.
3. User Personal Storage (Read/Write for Data Carrier User)
   This Storage allocation is used for personal data of the Data Carrier User (e.g. personal documents, images, videos, etc.) similar to a normal hard disk drive.

### Secondary Storage Devices:

The Permanent Storage will have inter-connectivity through the Carrier Device to other Storage Devices, (e.g. Removable HDD) Access to this device will only be possible through the specific Data Carrier Device that will be recognised, paired and authenticated through the Data Vending Solution. This will be identified by the Data Vending Solution as merely a pre-registered extension of the Data Carrier Device.

### Sourcing of Data:

Data sourcing can be done to any open standards database and data repository. The workflow below illustrates the necessary steps to source digital data effectively.

1. A method for securing ownership of data and/or performances which are broadcast and/or performed in public, said method including:
including an identifier in the broadcast and/or performed data;
transmitting the identifier at a frequency and/or modulation which is neutral to the primary purpose of the data;
receiving the broadcast and/or performance signal on a data carrier; and filtering the signal either at the time of reception thereof or at some point in time thereof to identify the identifier,
wherein the identified identifier is catalogued in relation to the data carrier.

2. (canceled)

3. A method as claimed in claim 1, wherein the identifier is used to select specific portions of the broadcast and/or performance which a user of the data carrier desires to legitimately obtain.

4. A method as claimed in claim 2, wherein the user either immediately downloads the selected portions or queues these portions for later download.

5. A method as claimed in claim 1, which method includes one or more steps selected from the group including:
recording an inventory of legally obtained data present on a specific data carrier;
interrogating an incoming signal or the data carrier on which said data and/or performance in the form of data has been saved for the identifier; and
reacting to the presence of the identifier or unrecognized data on the data carrier with one of a number of predetermined actions in response to whether unrecognized data is present or whether the identifier is recognized as being illicitly present on the data carrier or not when compared to the inventory.

6. A method as claimed in claim 1 wherein the identifier is an encrypted key and includes a catalogue number, a source identifier, a cost label, and/or information usually associated with bar-coding of tangible goods.

7. A method as claimed in claim 5, wherein the interrogation includes attempting to decrypt any unrecognized data so that
where decryption fails, data format cannot be recognized, or there is restriction of access to the data on the carrier device, responding with a predetermined action as if an illicit identifier had been recognized or any other predetermined action; or
where the identifier is read and decrypted and the data or performance is found to be authorized the data may be used normally.

8. A method as claimed in claim 5, wherein when the identifier is either not recognized or recognized to be illicit then the data carrier is locked and requires a corrective action to be taken selected from the group including, but not limited to, legalizing the data by paying for it, paying a fine, deleting the unauthorized data, deleting the entire content of the data carrier, and/or deactivating the data carrier.

9. (canceled)

10. A method as claimed in claim 1, which includes receiving the digital content carrying signal and which includes identifying the location at which the signal is received before permitting the data to be saved to the data carrier so that only a data carrier and/or a receiver at an authorized location is authorized to access content.

11. A method as claimed in claim 1, said method including:
including an identifier in data and/or performance;
transmitting the identifier at a frequency and/or modulation which is neutral to the primary purpose of the data and/or performance;
interrogating the performance and/or broadcast for the identifier; and
at the option of a user, marking for future download or real time capturing onto the data carrier a data set or a performance associated with the identifier,
which method includes processing payment for the marked and/or downloaded data, wherein the payment is in more than one stage, the first stage for marking and recording the selection to an inventory associated with a particular data carrier, and one or more further stages associated with the downloading and/or use of the data.

12. (canceled)

13. (canceled)

14. A broadcaster royalty control system, said system including:
uniquely allocating data carriers to a broadcaster;
indexing authorised and catalogued digital content which is installed on the carriers for a particular broadcaster;
uniquely tagging each item of digital content, such as a song, advertisement or other audio items with a unique catalogue number and/or other information in a transmittable format which is neutral to the purpose of the digital content; and
downloading or streaming digital content the broadcasting carrier(s) from a controlling depository, which downloading or streaming may be as updates or new data content.

15. A system as claimed in claim 10, providing for a radio station choosing an item to be broadcast from a menu on its broadcasting carrier so that, as such item is broadcast, the broadcasting carrier logs such item as having been broadcast with relevant supporting detail, such as date and time references, for the purpose of tallying and control.

16. A system as claimed in claim 11, wherein the item is tallied upon either partial or complete broadcast thereof.

17. (canceled)

18. A system as claimed in claim 12, wherein royalties for music played by a radio station are allocated and distributed accurately in real time, based on the monthly or other periodic reports.

19. A system as claimed in claim 12, wherein the cost of advertising is managed and controlled in terms of time aired or incidences over the air.

20. A system as claimed in claim 10, wherein a listener accesses the catalogue reference of an item through an adapted receiver, such as a car radio or tuner, and can store this item on a user data carrier as a potential purchase on a storable shopping list or order the purchase of this item from the vendor such as a radio station.

21. A system as claimed in claim 15, wherein a data repository receives the user's order via the vendor which receives a potential commission on the sale, and after payment has been received the repository allows the specific user data carrier to download or stream the permanently or temporarily purchased digital content to that specific user data carrier in a uniquely encrypted format.

22. A system as claimed in claim 10, which includes identifying the location at which the data is received before permitting the data to be saved to the data carrier.

23. (canceled)

24. (canceled)

25. A copyright management system for performed content which is performed live, said system including:
providing a source of a unique identifier to be associated with a live performance, such as a catalogue number and a digital signature;
transmitting the unique identifier contemporaneously with the live performance; and
depositing with a data repository the unique identifier so that, if a data carrier user connects to the data repository to download data and the unique identifier associated with the live performance is found but is not authorised, then appropriate corrective measures may be instituted.
